(19) United States
(12) Patent Application Publication
(10) Pub. No.: US 2004/0203695 A1
(43) Pub. Date: Oct. 14, 2004

(54) System and method for changing device settings relative to instant messaging presence

(76) Inventor: Jeffrey Clinton Mikan, Cumming, GA (US)

Correspondence Address: CINGULAR WIRELESS, 5565 GLENRIDGE CONNECTOR, 9TH FLOOR MC 920, C/O LINDA GILES, SYSTEM ANALYST, ATLANTA, GA, 30342, US

(21) Appl. No.: 10/313,811

(22) Filed: Dec. 6, 2002

(51) Int. Cl. H04M 3/00

(52) U.S. Cl. 455/419; 455/418; 455/420; 455/414.1

(57) ABSTRACT

The present invention is a method and apparatus for changing the settings of a communication device relative to the instant messaging presence of the communication device on a telecommunications network. In a first embodiment, the present invention receives an indication of changed instant messaging presence of the communication device on the telecommunications network. The present invention then changes the settings of the communication device to the settings corresponding to changed instant messaging presence. In a second embodiment, the communication device receives the indication of changed instant messaging presence via a client device from a client device, then adjusts the settings of the communication device to the settings corresponding to changed instant messaging presence.

### FIELD OF THE INVENTION

The present invention generally relates to the field of telecommunications, and more particularly, relates to a system and method for changing the settings of a communication device relative to the instant messaging presence of a user profile logged into the communication device on a telecommunications network.

### BACKGROUND OF THE INVENTION

Instant messaging services, accessible via a computer device or other communication device, enable users of such services to exchange messages or information with each other in near real-time. A feature of instant messaging services is a personal list, sometimes referred to as a “buddy list”, which includes identification of other users with whom the user frequently communicates via the instant messaging services. The availability status of other users on the personal list, known as the instant messaging presence of each user, includes not only “online” or “offline,” but user-controlled statuses, such as “gone to a movie,” “on the phone,” or “eating dinner.” Generally, the user-controlled statuses may be changed in response to an input from the user interface, such as receipt of a selection of an instant messaging presence via a drop-down menu presented on the display of the communication device.

Currently, if a user wishes for others on the personal list to know that the user is unavailable for instant messaging purposes, the user makes the selection of the appropriate instant messaging presence on the communication device. Upon receipt of the change in instant messaging presence, the user device communicates a signal representative of the instant messaging presence to the telecommunications network. Then, upon receipt of this signal, the telecommunications network communicates the new instant messaging presence to the other users on the personal list by publishing the instant messaging presence on the display of other devices in communication with the user device.

However, there are many inconveniences posed to the user by this process. For instance, many users carry their communication devices into areas where a loud ring may be obtrusive to those around the user, such as a movie theater. Currently, there is no mechanism for the device itself to be modified in response to a change in instant messaging presence. This feature would be helpful to users of communication devices because, many times, the situation which calls for a change in instant messaging presence may also require a change in the settings of the communication device. Thus, in such a situation, the user must not only change the instant messaging presence, but also must take the added step of changing any settings appropriate for the location, such as changing the ring type to vibrate.

This process may also cause further aggravation for a user because the user may forget to change the ring settings in addition to changing instant messaging presence. Another possibility is the user may be in such a hurry as to lack the time to make the change. This oversight could prove quite embarrassing to the user, and irritating to those around the user, should an incoming call generate a ring tone in an inappropriate location, such as in church, a movie theater, a classroom, or a library.

In another situation, a communication device may be coupled to a client device. An example of this embodiment includes a personal computer with telephonic capabilities incorporated within the functionality of the computer, wherein the telephonic capabilities may be operated via the user interface of the personal computer. Another example of this embodiment includes a wireless device communicatively coupled to another device such as a personal digital assistant device (“PDA” device), wherein the user may control the operation of the communication device via the interface of the PDA device.

Currently, in this situation, a user may change instant messaging presence of a user profile logged into the communication device via the user interface of the client device. However, this process also causes additional inconvenience to the user, for the user must take the additional step of changing any settings desired via the communication device in addition to changing the instant messaging presence via the client device.

Therefore, there is a need in the art for system and method for changing the settings of a communication device relative to the instant messaging presence of a user profile logged into the communication device on a telecommunications network. There is also a need for an implementing this feature in such a way that the customer, after changing instant messaging presence, is not required to take the additional step of changing the settings of the communication device, even when the communication device is coupled to a client device.

### SUMMARY OF THE INVENTION

Generally stated, the present invention provides a method and apparatus for adjusting the settings of a communication device. In particular, the present invention provides a method and apparatus for changing the settings of a communication device relative to the instant messaging presence of a user profile logged into the communication device on a telecommunications network.

In the preferred embodiment, the method comprises the steps of changing the instant messaging presence of the user profile logged into the communication device and adjusting the settings of the communication device in response thereto. The communication device receives a changed instant messaging presence indicator regarding the user profile from the telecommunications network. Once this changed instant messaging presence indicator is received, the present invention determines the settings corresponding to changed instant messaging presence, and then changes the settings of the communication device to the settings corresponding to changed instant messaging presence. The settings that may be changed include, but are not limited to, the ring type, the ring volume, and display options such as increased or decreased brightness.

In another disclosed embodiment, the method includes changing the instant messaging presence of a user profile in response to input via a desktop client, such as a personal computer communicatively linked to a communication device. The telecommunications network receives the changed instant messaging presence indicator regarding the user profile, and communicates the changed instant messaging presence indicator to the communication device, which responsive thereto, adjusts the settings.

Therefore, it is an object of the present invention to provide a rapid and user friendly process for changing the settings of a communication device relative to a change to the instant messaging presence of a user profile logged into the communication device on a telecommunications network.

It is also an object of the present invention to provide a process for changing the settings of a communication device relative to a change to the instant messaging presence of the user profile logged into the communication device on a telecommunications network when the communication device is coupled to a client device.

It is a further object of the present invention to provide an system for changing the settings of a communication device relative to the instant messaging presence of a user profile logged into the communication device on a telecommunications network.

Still another object of the present invention is to provide a system for changing the settings of a communication device relative to the instant messaging presence of a user profile logged into the communication device on a telecommunications network when the communication device is coupled to a client device.

That the present invention and the preferred embodiment thereof overcome the drawbacks set forth above and accomplish the objects of the invention set forth herein will become apparent from detailed description of the present invention to follow.

### BRIEF DESCRIPTION OF THE DRAWINGS

Preferred and alternative embodiments will now be described with reference to the attached figures wherein like reference numerals indicate similar or identical features or functions, and wherein:

FIG. 1 is a block diagram representation representing an exemplary system in accordance with the first embodiment of the present invention.

FIG. 2 is a block diagram representation of the data storage unit of the communication device in accordance with the first embodiment of the present invention.

FIG. 3 is a block diagram representing an exemplary system in accordance with the second embodiment of the present invention.

FIG. 4 is a flow diagram illustrating the first embodiment of the present invention from the perspective of the communication device.

FIG. 5 is a flow diagram illustrating the second embodiment of the present invention from the perspective of the system.

### DETAILED DESCRIPTION

Generally stated, the present invention provides a method and system for adjusting the settings of a communication device. In particular, the present invention provides a method and system for changing the settings of a communication device relative to the instant messaging presence of the communication device on a telecommunications network.

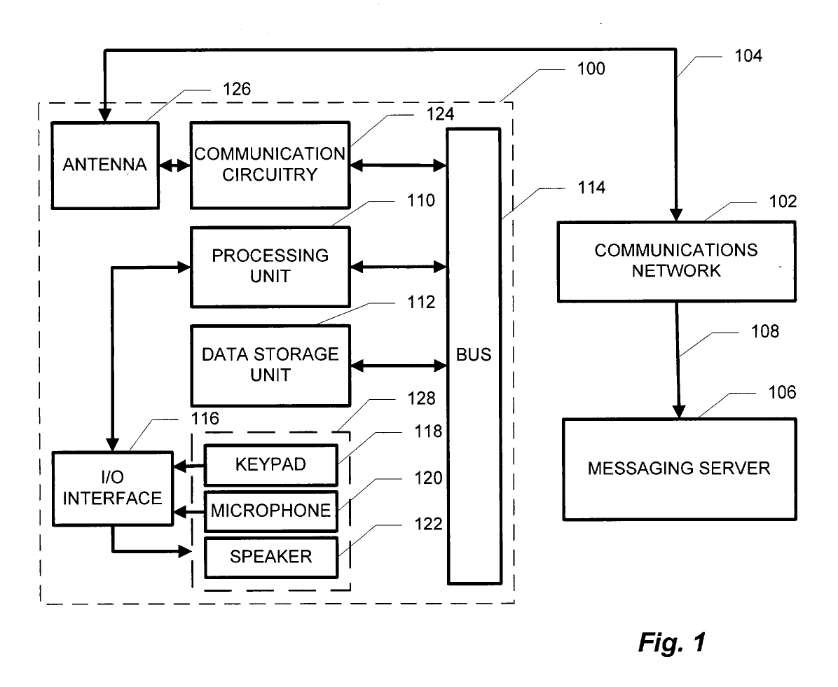

FIG. 1 is an overall system diagram illustrating the exemplary system in accordance with the first embodiment of the present invention. The communication device 100 places and receives voice or data calls using telecommunications network 102, in addition to any other communications, via a bi-directional communications link 104. Messaging server 106 may also communicate with communication device 100, and is coupled to telecommunications network 102 via a bi-directional communications link 108.

Communication device 100 may be any device capable of receiving and transmitting data. In the first embodiment of the present invention, this communication device 100 is a mobile device. Communication device contains a processing unit 110 which is communicatively coupled via bi-directional communications link to the other components of the communication device via a bus 114.

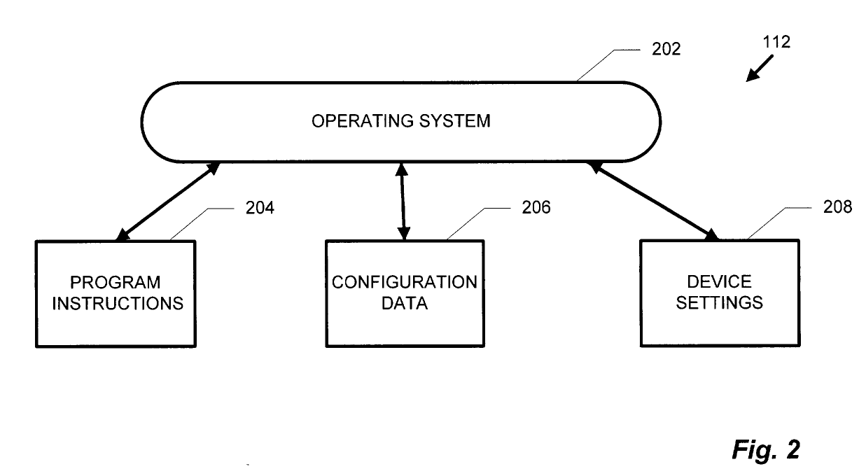

Communication device 100 is known in the art. Communication device 100 contains a data storage unit 112, which is discussed in greater detail in FIG. 2. Data storage unit 112 may be any type of volatile or non-volatile memory, including but not limited to RAM, EPROM, or EEPROM memory. The processing unit 110 and the data storage unit 112 may communicate via a system bus 114. Alternatively, the processing unit 110 and the data storage unit 112 may be included on the same microprocessing chip.

Communication device 100 also includes I/O interface 116, which may reside on the same microprocessing chip as the processing unit 110. However, I/O interface 116 may also reside on an external unit. I/O interface 116 connects the processing unit 110 to a user interface 128. In the case of a wireless device such as a cellular telephone, user interface 128 comprises keypad input 118, microphone input 120, and speaker output 122. The I/O interface 116 may include an analog-to-digital converter for converting an analog microphone signal to a digital signal for use by the processing unit 110. I/O interface 116 may also include a digital-to-analog converter to convert digital information from the processing unit 110 to the speaker, such as voice data.

The processing unit 110 transmits and receives digital signals which are to be communicated outside the communication device 100 via the communication circuitry 124. In a cellular telephone embodiment, the communication circuitry 124 is connected to an antenna 126, which communicates signals through airwaves via a bi-directional communication link 104.

Telecommunications network 102 receives signals from the communication device 100 via antenna 126. Telecommunications network 102 includes various components required to enable communication between two or more communication devices, including wired connections, wireless connections, switches, and other devices for establishing communication in the network. Telecommunications network 102 may also be communicatively coupled to a messaging server 106 via a bi-directional communication link 108. This messaging server 106 may be any computer system communicating with the telecommunications network 102 providing messaging capabilities to communication devices, including a server of a wireless service provider.

FIG. 2 is a block diagram representation of the data storage unit 112 of the communication device in accordance with the first embodiment of the present invention. Data storage unit 112 comprises operating system 202, which contains instructions for operating the communication device 100. In addition to any other instructions, the program instructions unit 204 includes instructions, which when executed by processing unit 110, execute the methods disclosed in the first and second embodiments of the present invention. The configuration data unit 206 is included in the data storage unit 112, and contains information regarding the assortment of components that make up the system of the present invention.

The data storage unit also contains a device settings unit 208. The device settings unit 208 contains various parameters indicating the settings of the communication device 100, in addition to any other data. One of these parameters may include a ring indicator value for indicating the type of ring associated with the communication device 100. Other device settings which may be stored in the device settings unit 208 include, but are not limited to, ring type, touch tone type, or appearance of the user interface 128.

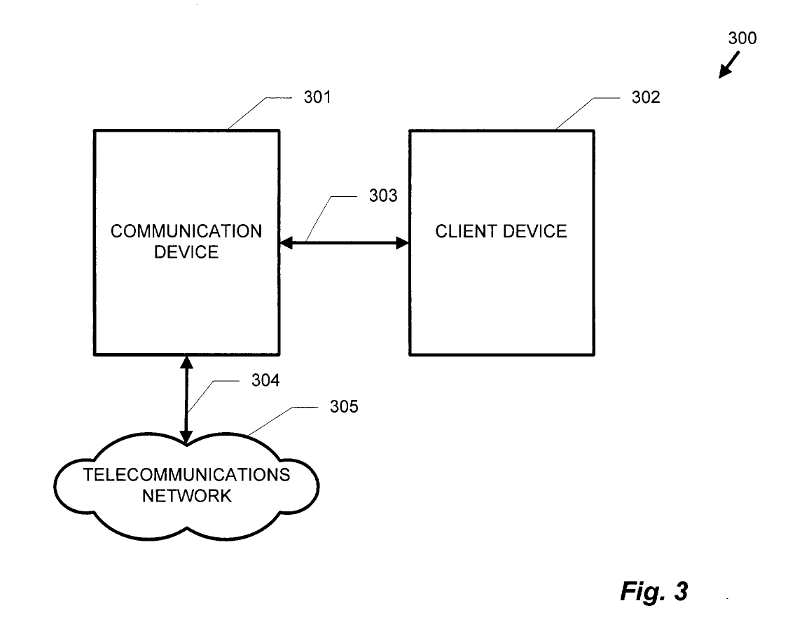

FIG. 3 is a block diagram representation representing an exemplary system in accordance with the second embodiment of the present invention. System 300 involves a communication device 301 connected to a client device 302. In this second embodiment, the communication device 301 may be similar to communication device 100 described in FIG. 1, but also may be a substantially different device. Communication device 301 is connected via a bi-directional communications link 304 to a telecommunications network 305. A bi-directional communication link 303 communicatively couples the client device 302 and the communication device 301. Furthermore, the client device 302 may comprise any device capable of operating with a communication device 301 such as a personal computer or another wireless device.

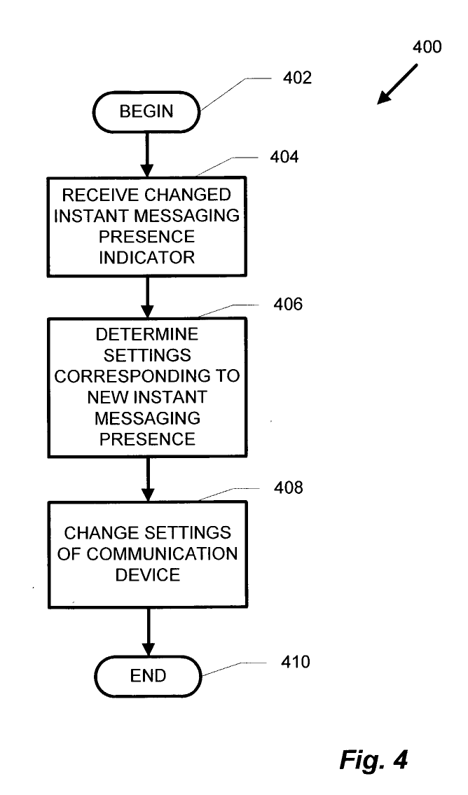

FIG. 4 is a flow diagram illustrating the method of the preferred embodiment of the present invention. Method 400 is a method of operation of the wireless communication device in accordance with the first embodiment. Method 400 begins at step 402 and proceeds to the receipt of the changed instant messaging presence indicator at step 404. More particularly, at step 404, processing unit 110 receives a signal indicating a change in the instant messaging presence of the user profile logged into the communication device

The changed instant messaging presence indicator may comprise various forms depending on the capabilities and functionality of the communication device 100. The possibilities for the indicator include, but are not limited to, a key sequence entered into the communication device 100 via the keypad 118, a dedicated button on the body of the communication device 100, an option selected by a user via a drop down menu presented on the user interface 128 of the communication device 100, or a voice command uttered by the user received via microphone 120. The changed instant messaging presence indicator may also be a signal received in response to the communication device 100 entering a specific location, received via location-based services technology from telecommunications network 102. Another possibility includes generation of the changed instant messaging presence indicator upon arrival of a predetermined time or date received from an internal clock or external clock located within the telecommunications network 102.

At step 406, the communication device 100 determines the settings corresponding to the new instant messaging presence for the user profile. Different settings may be programmed for each possible instant messaging presence. These settings are stored in the memory of the communication device 100 in the device settings unit 208 of the data storage unit 112 in the preferred embodiment. However, these settings may also reside externally in an alternate memory. The settings associated with each instant messaging presence for the user profile may be programmed by the user via the user interface 128 of communication device 100, may be preprogrammed into the device settings component 208 of the data storage unit 112 of communication device 100 at the time of manufacture, or may reside on the telecommunications network 102 for communication to the communication device 100.

At step 408, the present invention changes the settings of the communication device 100 to the settings associated with the new instant messaging presence of the user profile. The settings may be any feature of the communication device 100, including but not limited to, the ring settings, ring volume, alternative notification functions, including vibration, appearance of the communication device display, or any other parameters included in device settings unit 208 of data storage unit 112. The method 400 concludes at step 410 after the settings of the communication device 100 are changed to reflect the new instant messaging presence.

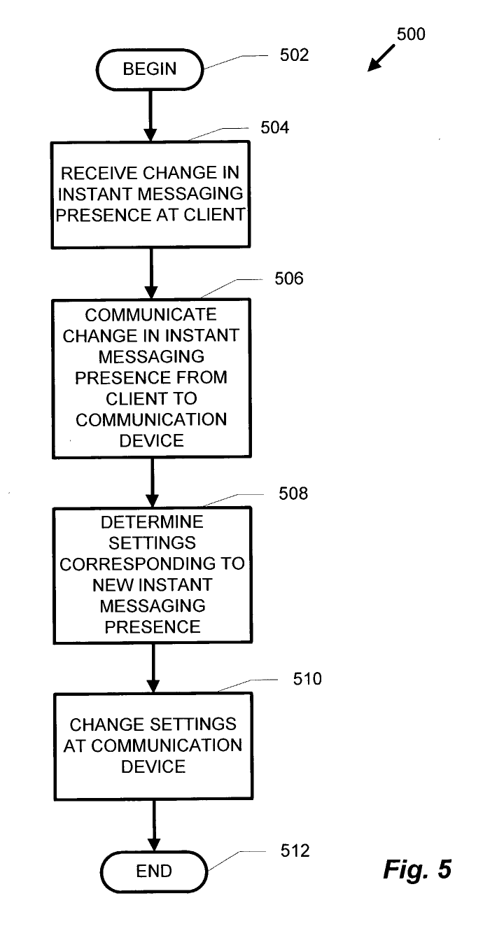

FIG. 5 is a flow diagram illustrating the second embodiment of the present invention. Method 500 is utilized when the communication device 100 is connected to a client device 302 in accordance with the second embodiment of the present invention. This second embodiment may include a personal digital assistant (PDA) device that is connected to a mobile communication device.

After method 500 begins at step 502, the client device 302 receives a change in instant messaging presence at step 504. The possibilities for the changed instant messaging presence indicator include, but are not limited to, a key sequence entered into the communication device 100 via the keypad 118, a key sequence entered into the client device 302, a dedicated button on the body of the communication device 100 or the client device 302, an option selected by a user via a drop down menu presented on the user interface 128 of the communication device 100 or on the user interface of the client device 302, or a voice command uttered by the user received via microphone 120.

The changed instant messaging presence indicator may also be a signal received in response to the communication device 100 entering a specific location generated by location based services technology. Another possibility includes generation of the changed instant messaging presence indicator upon arrival of a predetermined time or date, either detected by an internal clock or a clock on the telecommunications network 102.

At step 506, the client device 302 communicates the change in instant messaging presence to the communication device 100. The client device 302 may communicate to the communication device 100 in any capable form, including but not limited to a wireless technology, such as a short-range radio technology including Bluetooth, or a wired connection.

At step 508, the communication device 100 determines the settings corresponding to the new instant messaging presence. These settings may be stored in memory of the communication device 100 or may reside in an external memory. Furthermore, the same settings may be programmed to correspond with any change in instant messaging presence, such as changing to silent or vibrate, or more specifically, different settings may be programmed to correspond with different instant messaging presences, such as a louder ring for “at a concert” instant messaging presence. At step 510, the communication device 100 alters the settings to reflect the changed instant messaging presence, and method 500 concludes at step 512.

It will be apparent to those skilled in the art that various changes and modifications of an obvious nature may be made to the present invention, and all such changes and modifications are considered to fall within the scope of the appended claims. Other embodiments of this invention will be apparent to those skilled in the art from consideration of the specification and practice of the invention disclosed herein. It is intended that the specification and examples be considered as exemplary only, and within the scope and spirit of the invention as indicated in the description and the following claims.

I hereby claim:

1. A method of changing the settings of a communication device relative to a change in the instant messaging presence of a user profile logged into the communication device on a telecommunications network, said method comprising:
receiving an indication of changed instant messaging presence of the user profile logged into the communication device on the telecommunications network;
determining settings corresponding to changed instant messaging presence, and
changing the settings of the communication device to the settings corresponding to changed instant messaging presence.

2. The method of claim 1, wherein said receiving a change in instant messaging presence step comprises receiving input from an interface on the communication device indicating a changed instant messaging presence.

3. The method of claim 2, wherein said receiving input via an interface on the communication device comprises receiving a key sequence entered on a keypad of the communication device.

4. The method of claim 2, wherein said receiving input via an interface on the communication device comprises receiving a selection of an item on a drop-down menu presented on the user interface of the communication device.

5. The method of claim 2, wherein said receiving input via an interface on the communication device comprises receiving a selection of a dedicated button on a body of the communication device.

6. The method of claim 1, wherein changing the settings of the communication device comprises changing the ring type.

7. The method of claim 1, wherein changing the settings of the communication device comprises changing the ring volume.

8. The method of claim 1, wherein changing the settings of the communication device comprises changing the appearance of a display on the communication device.

9. The method of claim 1, wherein said communication device comprises a wireless device.

10. The method of claim 9, wherein said communication device comprises a cellular telephone.

11. A method of changing the settings of a communication device relative to a change in the instant messaging presence of a user profile logged into the communication device coupled to a client device, said method comprising:
receiving an indication of changed instant messaging presence of the user profile logged into the communication device on the telecommunications network;
communicating the changed instant messaging presence to the communication device;
determining settings corresponding to changed instant messaging presence, and
changing the settings of the communication device to the settings corresponding to changed instant messaging presence.

12. The method of claim 11, wherein said receiving a change in instant messaging presence step comprises receiving input from an interface on the communication device indicating a changed instant messaging presence.

13. The method of claim 12, wherein said receiving input via an interface on the communication device comprises receiving a key sequence entered on a keypad of the communication device.

14. The method of claim 12, wherein said receiving input via an interface on the communication device comprises receiving a selection of an item on a drop-down menu presented on the user interface of the communication device.

15. The method of claim 12, wherein said receiving input via an interface on the communication device comprises receiving a selection of a dedicated button on a body of the communication device.

16. The method of claim 11, wherein changing the settings of the communication device comprises changing the ring type.

17. The method of claim 11, wherein changing the settings of the communication device comprises changing the ring volume.

18. The method of claim 11, wherein changing the settings of the communication device comprise's changing the appearance of a display on the communication device.

19. The method of claim 11, wherein said communication device comprises a wireless device.

20. The method of claim 11, wherein said communication device comprises a cellular telephone.

21. A system for causing a communication device to operate differently based at least in part on the instant messaging presence thereof in a telecommunication network, said system comprising:
a processing unit resident in the communication device;
a memory accessible to said processing unit for storing a data value related to the instant messaging presence of the communication device in the telecommunication network, said data value being changeable by a user of the communication device and representative of a mode of operation of the communication device;
a plurality of instructions executable by said processing unit to cause alteration of the operation of the communication device based at least in part on said data value.

22. The system of claim 21, wherein said system further comprises a user interface communicatively connected to said processing unit for receipt of input from a user of the communication device corresponding to an instant messaging presence of the communication device.

23. The system of claim 21, wherein said system further comprises a user interface communicatively connected to said processing unit for receipt of input from a user of the communication device corresponding to a mode of operation desired by the user.

24. The system of claim 22, wherein said user interface comprises a keypad.

25. The system of claim 22, wherein said user interface comprises a microphone.

26. The system of claim 25, wherein said user interface further comprises a speech recognition unit.

27. The system of claim 22, wherein said user interface comprises a touch screen.

28. The system of claim 22, wherein said plurality of instructions is a first plurality of instructions and said system further comprises a second plurality of instructions executable by said processing unit to cause storage of said data value in response to the receipt of input via said user interface.
